(19) United States
(12) Patent Application Publication
(10) Pub. No.: US 2002/0166423 A1
(43) Pub. Date: Nov. 14, 2002

(54) Cutting apparatus for generating threads for pipe nipples

(75) Inventor: Ronnie M. Willis, Jackson, TN (US)

Correspondence Address: MANELLI DENISON & SELTER, 2000 M STREET NW SUITE 700, WASHINGTON, DC, 20036-3307, US

(73) Assignee: MUELLER CO.

(21) Appl. No.: 10/077,805

(22) Filed: Feb. 20, 2002

Related U.S. Application Data
(60) Provisional application No. 60/269,399, filed on Feb. 20, 2001.

(51) Int. Cl. B23B 5/00; B23G 1/00

(52) U.S. Cl. 82/110; 82/113

(57) ABSTRACT

A thread milling cutter for forming threads on a pipe end is provided with a platform that is mounted on a slide table and movable by threaded connection to rod; the milling cutter includes a head supporting a plurality of milling cutters in separate, rotatable shafts with a common drive for all the shafts and if desired, for the head.

### CROSS REFERENCE TO RELATED APPLICATION

This application is based on provisional application Serial No. 60/269,399 filed Feb. 20, 2001 for the purpose of priority.

### BACKGROUND OF THE INVENTION

This invention relates to thread milling devices and more particularly to a cutting head for cutting threads in a periphery of a pipe to make a pipe nipple to facilitate connection to a coupling or other fluid handling member. In the past, it has been the practice in the fluid conduit field to cut threads in the ends of pipes to enable connection to other elements of a system such as valves, joints and the like. Equipment for cutting straight threads, that is, threads that lie a uniform radial distance from the axis of the pipe, have enjoyed widespread use for many years. However, the advantages of forming tapered, threaded nipples on pipe ends have become apparent. The problem faced by workers is that equipment for forming tapered threads is difficult to set up and slow to operate as well as expensive to acquire. Since the desirable characteristics of tapered thread nipples has increased demand for these types of pipe ends, there exists a need for an improved apparatus for quickly and accurately forming tapered pipe ends that can be threaded into associated conduit elements to assure fluid tight seals.

### BRIEF DESCRIPTION OF THE DRAWINGS

FIG. 1 is a side schematic view of a coaxial threading head apparatus provided in accordance with the principles of the present invention;

FIG. 2 is a front schematic view of the planetary, coaxial thread milling head of showing head milling cutters, timing belts, pulleys and the main head drive motor.

FIG. 3 is an enlarged view of the portion enclosed by circle A in FIG. 1.

### DETAILED DESCRIPTION OF THE INVENTION

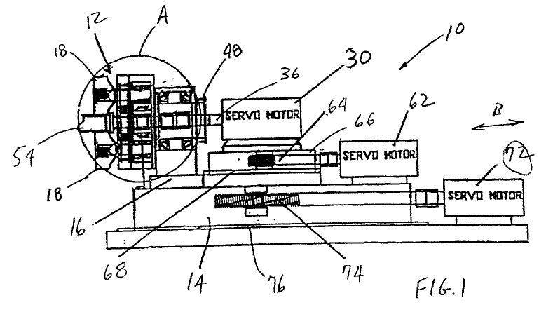

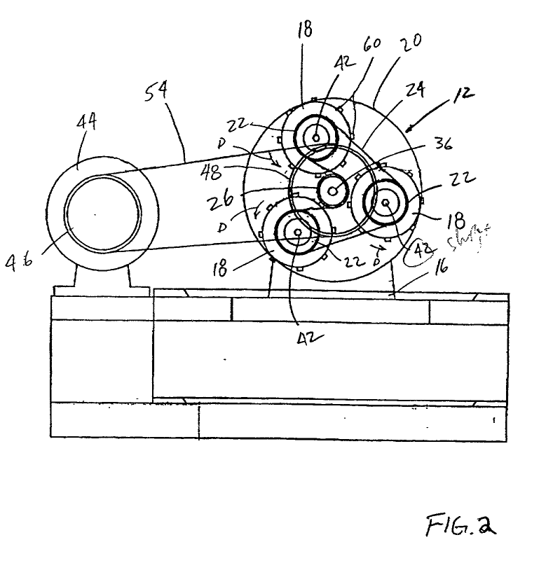

Referring to FIG. 1, a coaxial threading head apparatus for cutting threads in producing pipe nipples is shown, generally indicated 10, provided in accordance with the principles of the present invention. The apparatus 10 includes a planetary, coaxial thread milling head, generally indicated at 12, mounted on a movable platform 14 via a bearing housing 16. The milling head 12 includes a housing 20 and thread milling cutters 18. Each milling cutter 18 (three illustrated) is arranged to rotate about an associated shaft 42 in the direction of arrow D (FIG. 2).

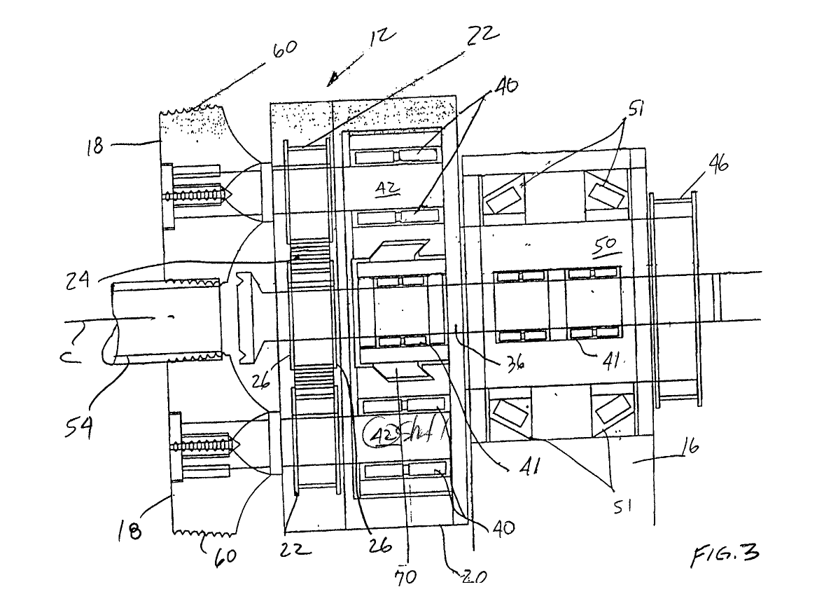

As best shown in FIGS. 2-3, each milling cutter 18 is coupled with a pulley 22 via the shaft 42. Shafts 42 are mounted for rotation via bearings 40. A timing belt 24 is operatively associated with the pulleys 22 and with a central pulley 26. A servo motor 44 causes simultaneous rotation of the milling cutters 18 about the associated shafts 42 at Computer Numeric Controlled (CNC) speeds. Control of motors including the feed speed of motor 72 are all computer controlled. Bearings 41 support the shaft 36 for rotation. Thus, rotation of shaft 36 causes movement of the central pulley 26 and timing belt 24 which causes rotation of the milling cutters 18 with respect to the pipe 54 fixed in a spindle 56, as will be explained more fully below.

With reference to FIGS. 2 and 3, the apparatus 10 includes a main head drive servo motor 44 which is coupled to a first pulley 46. A second pulley 48 is mounted on a shaft 50 (FIG. 4) which is coupled to housing 20 of the thread milling head 12. Thus, rotation of pulley 46 causes rotation of pulley 48, via timing belt 54, which causes rotation of shaft 50 supported by bearings 51. Rotation of shaft 50 cause rotation of the housing 20 and thus rotation of the entire thread milling head 12 about axis C.

As best shown in FIG. 3, the milling cutters 18 are constructed and arranged to receive the end of a pipe 54 to cut threads in a periphery thereof. Each milling cutter 18 carries multiple cutters 60 for cutting threads in the periphery of the pipe 54 upon simultaneous rotation of the milling cutters 18 about their associated shafts, and rotation of the entire thread milling head 12 about axis C. The cutters 60 can be changed for cutting tapered or straight threads.

It can be appreciated that the pipe 54 acts as a “sun gear”, which can be held by external supports, the milling cutters 18 act as “planet carries” and the housing 20 can be considered the “ring gear” of the planetary arrangement described above.

Certain portions of the apparatus 10 are also configured for axial movement. With reference to FIG. 1, a servo motor 62 moves a ball screw 64 to move platform 66 along a precision slide 68 in the direction of arrow B. Movement of the platform 66 causes a cam action via cam 70 (FIG. 4) to open and close the milling cutters 18.

In addition, a servo motor 72 moves a ball screw 74 to move platform 13 along a precision slide 76 in the direction of arrow B to move the complete assembly for a given pitch thread.

Thus, the apparatus provides a self-contained, coaxial thread milling head using multiple cutters with multiple teeth for very high speed thread cutting with low chip load per tooth.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An apparatus for cutting threads in a pipe, the apparatus comprising:
a thread milling head including a plurality of milling cutters, each milling cutter being mounted for rotation via an associated shaft and including at least one cutter, the milling cutters being constructed and arranged about a central axis to receive an end of a pipe disposed along the central axis, such that the cutters can cut threads in a periphery of the pipe,
means for causing simultaneous rotation of the milling cutters about their associated shafts, and
means for causing rotation of the thread milling head about the central axis.

2. The invention as claimed in claim 1 wherein said milling head is mounted on a platform, said platform being movably mounted on a slide member.

3. The invention as claimed in claim 2 wherein said means for moving said platform on said slice are provided.

4. The invention as claimed in claim 3 wherein said means for moving said platform includes rod rotatable by a motor, said rod having a threaded connection to said platform whereby rotation of said rod will cause movement of said platform on said slide.
